(19) United States
(12) Patent Application Publication
(10) Pub. No.: US 2015/0281303 A1
(43) Pub. Date: Oct. 1, 2015

(54) ADAPTIVE MEDIA STREAMING

(71) Applicants: Mohamed Yousef, Cairo (EG); Hani H. Elgebaly, Cairo (EG); Ahmed Y. Sobhi, Cairo (EG); Menna A. Ghoneim, Cairo (EG); Wafaa Taie, Cairo (EG)

(72) Inventors: Mohamed Yousef, Cairo (EG); Hani H. Elgebaly, Cairo (EG); Ahmed Y. Sobhi, Cairo (EG); Menna A. Ghoneim, Cairo (EG); Wafaa Taie, Cairo (EG)

(21) Appl. No.: 14/225,634

(22) Filed: Mar. 26, 2014

(51) Int. Cl. H04L 29/06; H04N 21/845; H04N 21/643; H04N 21/2343; H04N 21/433; H04N 21/44

(52) U.S. Cl. CPC H04L 65/602; H04N 21/433; H04N 21/44004; H04N 21/643; H04N 21/44008; H04N 21/234345; H04N 21/8456

(57) ABSTRACT

Technology for performing dynamic adaptive streaming over hypertext transfer protocol (DASH) is described. A planned route may be selected for a mobile device. Wireless channel information may be received for the planned route from a channel information database (CID). Geographical locations along the planned route where wireless network channel conditions are below a defined threshold may be determined based on the wireless channel information. Additional segments of a media file may be requested from a media server prior to entering the determined locations along the planned route.

### BACKGROUND

The growth of multimedia services, including streaming and conversational services, is one of the key drivers of the evolution to new mobile broadband technologies and standards. Digital video content is increasingly consumed in mobile devices. As more smart phones, tablets, and other mobile computing devices are purchased, their use for video recording and video conferencing will increase dramatically. With such high consumer demand for multimedia services coupled with developments in media compression and wireless network infrastructures, it is of interest to enhance the multimedia service capabilities of future cellular and mobile broadband systems and deliver high quality of experience (QoE) to the consumers, thereby ensuring ubiquitous access to video content and services from any location, at any time, with any device and technology.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a block diagram of a media presentation description (MPD) metadata file configuration in accordance with an example;

FIG. 2 illustrates a block diagram of hypertext transfer protocol (HTTP) streaming in accordance with an example;

FIG. 3 illustrates a block diagram of an energy characterization-aware radio access network (RAN) architecture for hypertext transfer protocol-based (HTTP-based) video streaming in accordance with an example;

FIG. 4 illustrates network conditions along a planned route and the caching of media segments at specific locations along the planned route to improve a user quality of experience in accordance with an example;

FIG. 5 depicts functionality of computer circuitry of a user equipment (UE) operable to perform adaptive media streaming in accordance with an example;

FIG. 6 depicts a flowchart of a method for performing dynamic adaptive streaming over hypertext transfer protocol (DASH) in accordance with an example;

FIG. 7 depicts functionality of computer circuitry of a user equipment (UE) operable to perform dynamic adaptive streaming over hypertext transfer protocol (DASH) in accordance with an example; and

FIG. 8 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Hypertext transfer protocol (HTTP) adaptive streaming (HAS) can be used as a form of multimedia delivery of Internet video. HTTP-based delivery can provide reliability and deployment simplicity due to a broad adoption of both HTTP and HTTP's underlying protocols, including transmission control protocol (TCP)/internet protocol (IP). HTTP-based delivery can enable easy and effortless streaming services by avoiding network address translation (NAT) and firewall traversal issues. HTTP-based delivery or streaming can also provide the ability to use standard HTTP servers and caches instead of specialized streaming servers. HTTP-based delivery can provide scalability due to minimal or reduced state information on a server side.

When using HAS to deliver internet multimedia content, a video client operating on a mobile device can be configured to perform the primary role in rate adaptation by choosing and requesting the appropriate video representation levels from a video server using an HTTP GET or partial GET command to retrieve data from a specified resource, such as a multimedia server. The video client initially builds up a buffer to a certain level before beginning to playback streaming multimedia content, such as audio or video. This phase is referred to as the start-up phase. After this, the client begins playback of the buffered multimedia content. The quality and resolution of the multimedia playback at the client device is dependent on the available link bandwidth. The video client typically estimates the available link bandwidth based only on higher layer throughput estimates, such as HTTP-level video streaming throughput, or on transmission control protocol (TCP) throughput.

Multimedia streaming in a high mobility environment may be challenging when fluctuations in network conditions (i.e., network variability) decreases a communication data rate associated with the multimedia content. When an overloaded network causes the communication data rate to decrease, an end user quality of experience (QoE) may decrease as well. For example, the multimedia content received at the mobile device may be of less resolution or quality and/or the multimedia content may periodically break or pause when being provided over the overloaded network.

The use of progressive download based streaming techniques in mobile networks of limited resources may be undesirable due to inefficient bandwidth utilization and poor end user quality of experience. As discussed in further detail below, hyper-text transfer protocol (HTTP) based streaming services, such as dynamic adaptive streaming over HTTP (DASH), may be used to address weaknesses of progressive download based streaming.

Multimedia content that is streamed to a client, such as a user equipment (UE), may include a plurality of multimedia content segments. The multimedia content segments may each contain different encoded versions that represent different qualities levels of the multimedia content. The different encoded versions may allow the client to seamlessly adapt to changing network conditions. For example, when the network conditions are good (i.e., the network conditions are above a predetermined threshold), the client may request multimedia content segments that are of a higher video quality. When the network conditions are poor (i.e., the network conditions are below a predetermined threshold), the client may request multimedia content segments that are of a lower video quality. As a result, the client may still be able to receive the multimedia content segments (albeit at a lower quality) when the network conditions are poor and a likelihood of the adaptive media stream being interrupted may be reduced.

In DASH, the client may select the multimedia content segments with a highest bit rate, such that the multimedia content segments can be downloaded at the client in time for media playback without causing a rebuffering event in the media playback. In other words, the client may not select multimedia content segments that are so high that the adaptive media stream is periodically interrupted in order to cache or preload a portion of the media content onto the client before resuming media playback at the client. In one example, adverse network conditions may degrade a quality of the media content stream. The adverse network conditions may include coverage nulls, abrupt bandwidth changes, packet losses, substantial delay variations, etc. Although adaptive streaming techniques may consider current network conditions when calculating an available throughput and determining an appropriate streaming bit rate based on the available throughput, smooth media playback at the client may not be guaranteed during abrupt network variations and/or adverse network conditions.

Therefore, in order to maintain a desirable quality of experience for an adaptive media stream at the client, the client's planned route and current network conditions along the planned route may be used to strategically cache the multimedia content segments at the client, thereby resulting in smoother media playback and an enhanced quality of experience at the client. The client may select a planned route (i.e., a geographical route that the client is about to embark on). The client may be streaming media content (e.g., a movie) while traveling on the planned route. In one example, the client may include a mobile device located within a moving vehicle or a computing device of the vehicle. The client may receive current network conditions for the planned route from a channel information database (CID). The current network conditions may include certain locations along the planned route (e.g., tunnels, bridges, remote areas) with corresponding network conditions that are below a predetermined threshold. The client may request additional media content segments of the media content (e.g., additional segments of the movie) from a media content server and then store the additional media content segments in the cache. When the client reaches the locations along the planned route with network conditions that are below the predetermined threshold, the client may playback media content that is stored in the cache. As a result, continuous media playback may be substantially provided at the client, even during times when current network conditions along the planned route fall below the predetermined threshold.

### Wireless Multimedia Standards

There have been a number of multimedia standards that have been developed to enable multimedia to be communicated to, from, or between mobile computing devices. For instance, in streaming video, the third generation partnership project (3GPP) has developed technical specification (TS) 26.234 (e.g. Release 11.0.0) that describes packet-switched streaming services (PSS) that are based on the real-time streaming protocol (RTSP) for unicast streaming of on-demand or live content. In addition, hyper-text transfer protocol (HTTP) based streaming services, including progressive download and dynamic adaptive streaming over HTTP (DASH), are described in 3GPP TS 26.247 (e.g. Release 11.0.0). 3GPP-based multimedia broadcast and multicast services (MBMS) specification TS 26.346 (e.g. Release 11.0.0) specifies streaming and download techniques for multicast/broadcast content distribution. As such, DASH/PSS/MBMS-based mobile computing devices, such as user equipment (UEs), decode and render streamed videos at the UE devices. Support for the 3GP file format in 3GPP TS 26.244 (e.g. Release 11.0.0) is mandated in all of these specifications to support file download and HTTP-based streaming use cases.

One example of a standard for conversational video communication, such as video conferencing, is provided in 3GPP TS 26.114 (e.g. 11.0.0). The standard describes the multimedia telephony services over IMS (MTSI) that allows delivery of advanced multimedia conversational services and content over internet protocol (IP) multimedia subsystems (IMS) based networks. IMS is standardized in 3GPP TS 26.140 (e.g. Rel. 11.0.0). An MTSI-based transmitter UE terminal can capture and record video, and then transfer the video to an MTSI-based receiver UE terminal over a 3GPP network. The receiver UE terminal can then decode and render the video. The 3GPP TS 26.140 also enables video sharing using multimedia sharing services (MMS), in which support for the 3GP file format is provided.

The standards described above are provided as examples of wireless multimedia standards that can be used to communicate multimedia files to, from, and/or between multimedia devices. The examples are not intended to be limiting. Additional standards may be used to provide streaming video, conversational video, or video sharing.

### Streaming Media Standards

A more detailed explanation of HTTP streaming, and more particularly, the DASH standard is provided herein, in context with embodiments of the present invention. The detailed explanation is not intended to be limiting. As will be further explained in the proceeding paragraphs, the embodiments of the present invention can be used to efficiently communicate multimedia to, from, and/or between mobile devices by enabling the mobile devices, or the servers in communication with the mobile devices, to select and/or communicate multimedia having a desired energy characterization. The multimedia can be communicated using a standardized or non-standardized communication scheme.

Hypertext transfer protocol (HTTP) streaming can be used as a form of multimedia delivery of Internet video. In HTTP streaming, a multimedia file can be partitioned into one or more segments and delivered to a client using the HTTP protocol. HTTP-based delivery can provide reliability and deployment simplicity due to a broad adoption of both HTTP and HTTP's underlying protocols, including transmission control protocol (TCP)/internet protocol (IP). HTTP-based delivery can enable simplified streaming services by avoiding network address translation (NAT) and firewall traversal issues. HTTP-based delivery or streaming can also provide the ability to use standard HTTP servers and caches instead of specialized streaming servers. HTTP-based delivery can provide scalability due to minimal or reduced state information on a server side. Examples of HTTP streaming technologies can include Microsoft IIS Smooth Streaming, Apple HTTP Live Streaming, and Adobe HTTP Dynamic Streaming.

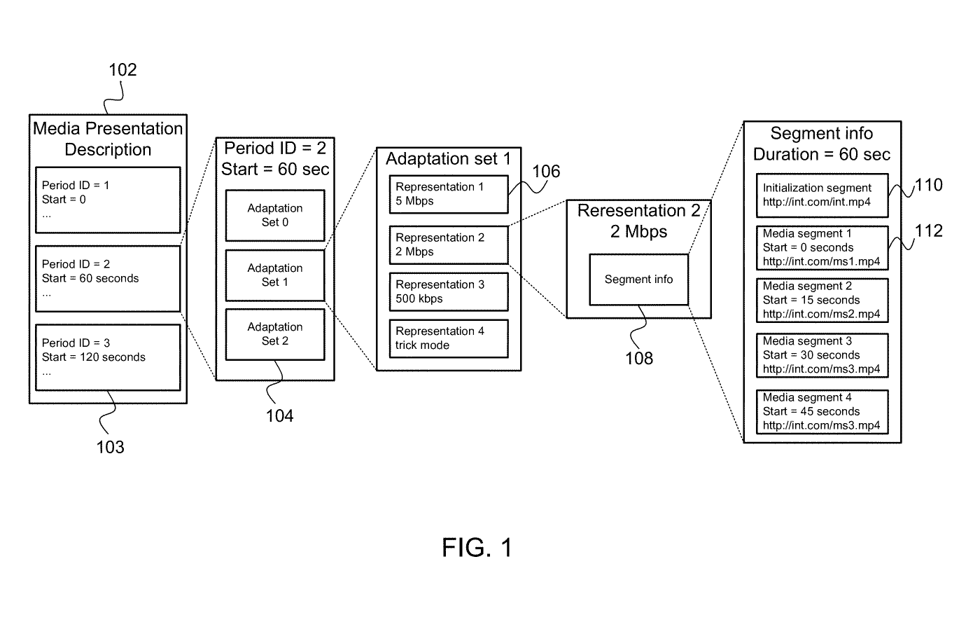

DASH is a standardized HTTP streaming protocol. As illustrated in FIG. 1, DASH can specify different formats for a media presentation description (MPD) metadata file 102 that provides information on the structure and different versions of the media content representations stored in the server as well as the segment formats. The MPD metadata file contains information on the initialization and media segments for a media player (e.g., the media player can look at initialization segment to determine a container format and media timing information) to ensure mapping of segments into a media presentation timeline for switching and synchronous presentation with other representations. DASH technology has also been standardized by other organizations, such as the Moving Picture Experts Group (MPEG), Open IPTV Forum (OIPF), and Hybrid Broadcast Broadband TV (HbbTV).

A DASH client can receive multimedia content by downloading the segments through a series of HTTP request-response transactions. DASH can provide the ability to dynamically switch between different bit rate representations of the media content as the bandwidth that is available to a mobile device changes. Thus, DASH can allow for fast adaptation to changing network and wireless link conditions, user preferences and device capabilities, such as display resolution, the type of central processing unit (CPU) employed, the memory resources available, and so forth. The dynamic adaptation of DASH can provide a better quality of experience (QoE) for a user, with shorter startup delays and fewer rebuffering events than other streaming protocols.

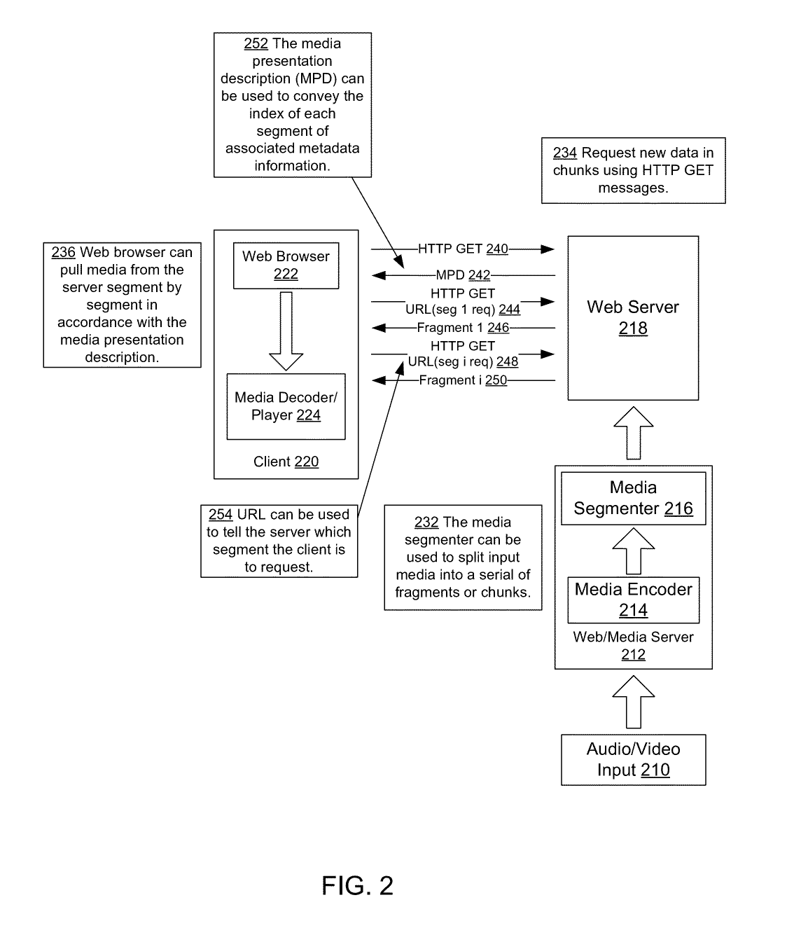

In DASH, a media presentation description (MPD) metadata 102 can provide information on the structure and different versions of the media content representations stored in a web/media server 212, as illustrated in FIG. 2. In the example illustrated in FIG. 1, the MPD metadata is temporally divided into periods having a predetermined length, such as 60 seconds in this example. Each period can include a plurality of adaptation sets 104. Each adaptation set can provide information about one or more media components with a number of encoded alternatives. For example, adaptation set 0 in this example might include a variety of differently encoded audio alternatives, such as different bit rates, mono, stereo, surround sound, and so forth. In addition to offering different quality audio for a multimedia presentation over the period ID, the adaptation set may also include audio in different languages. The different alternatives offered in the adaptation set are referred to as representations 106.

In FIG. 1, Adaptation set 1 is illustrated as offering video at different bitrates, such as 5 mega-bits per second (Mbps), 2 Mbps, 500 kilo-bits per second (kbps), or a trick mode. The trick mode can be used for seeking, fast forwarding, rewinding, or other changes in location in the multimedia streaming file. In addition, the video may also be available in different formats, such as two dimensional (2D) or three dimensional (3D) video. Each representation 106 can include segment information 108. The segment information can include initialization information 110 and the actual media segment data 112. In this example, an MPEG 4 (MP4) file is streamed from a server to a mobile device. While MP4 is used in this example, a wide variety of different codecs may be used, as previously discussed.

The multimedia in the adaptation set can be further divided into smaller segments. In the example of FIG. 1, the 60 second video segment of adaptation set 1 is further divided into four sub-segments 112 of 15 seconds each. These examples are not intended to be limiting. The actual length of the adaptation set and each media segment or sub-segment is dependent on the type of media, system requirements, potential types of interference, and so forth. The actual media segments or sub-segments may have a length that is less than one second to several minutes long.

As shown in FIG. 2, the MPD metadata information can be communicated to a client 220, such as a mobile device. A mobile device can be a wireless device configured to receive and display streaming media. In one embodiment, the mobile device may only perform part of this function, such as receiving the streaming media and then communicating it to another device or a display device for rendering. The mobile device can be configured to run a client 220. The client can request the segments using an HTTP GET 240 message or a series of partial GET messages. The client can control the streaming session, such as managing an on-time request and smooth play-out of a sequence of segments, or potentially adjusting bitrates or other attributes, to react to changes of a wireless link, a device state or a user preference.

FIG. 2 illustrates a DASH-based streaming framework. A media encoder 214 in the web/media server 212 can encode an input media from an audio/video input 210 into a format for storage or streaming. A media segmenter 216 can be used to split the input media into a series of segments 232, which can be provided to a web server 218. The client 220 can request new data in segments using HTTP GET messages 234 sent to the web server (e.g., HTTP server).

For example, a web browser 222 of the client 220 can request multimedia content using a HTTP GET message 240. The web server 218 can provide the client with a MPD 242 for the multimedia content. The MPD can be used to convey the index of each segment and the segment's corresponding locations as shown in the associated metadata information 252. The web browser can pull media from the server segment by segment in accordance with the MPD 242 as shown in 236. For instance, the web browser can request a first segment using a HTTP GET URL(frag 1 req) 244. A uniform resource locator (URL) or universal resource locator can be used to tell the web server which segments the client is to request 254. The web server can provide the first fragment (i.e., segment 1 246). For subsequent segments, the web browser can request a segment i using a HTTP GET URL(frag i req) 248, where i is an integer index of the segment. As a result, the web server can provide a segment i 250. The segments can be presented to the client via a media decoder/player 224.

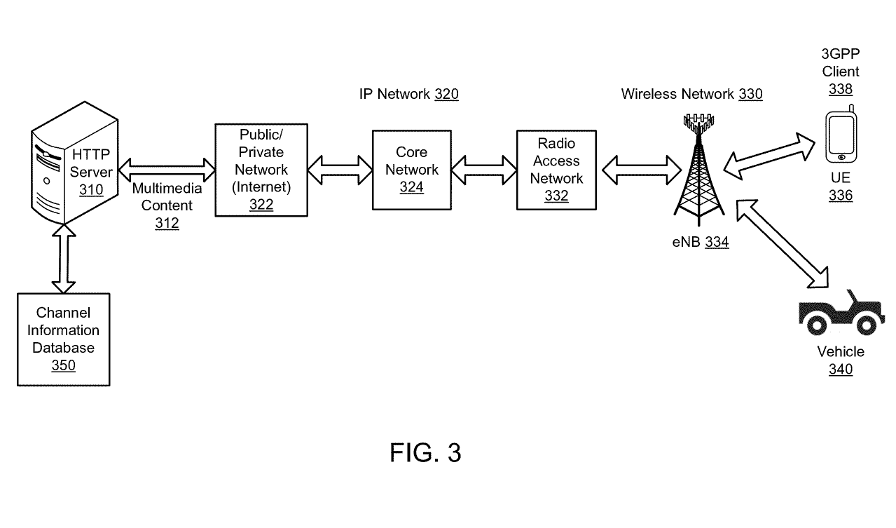

FIG. 3 illustrates a flow of multimedia content 312 between an HTTP server 310 providing the multimedia content to a 3GPP client 338 operating on a mobile device, such as a UE 336. The HTTP server can interface with a public or private network 322 (or the Internet) in communication with a core network 324 of a wireless wide area network (WWAN). In one embodiment, the WWAN can be a 3GPP LTE based network or an IEEE 802.16 based network (i.e. 802.16-2009). The core network can access a wireless network 330, such as an evolved packet system (EPS) via a radio access network (RAN) 332. The RAN 332 can provide the multimedia content to the client operating on the UE 336 via a node (e.g., an evolved Node B (eNB) 334).

In one example, the HTTP server 310 may be coupled to a channel information database 350. The channel information database 350 may include current network conditions for a plurality of geographical locations. The plurality of geographical locations may include particular roads, streets, neighborhoods, geographical regions, bridges, tunnels, etc. The current network conditions may be based on real-time monitoring of the current network conditions for the plurality of geographical locations. Therefore, the channel information database 350 may be dynamically updated due to variations in the current network conditions. Alternatively, the current network conditions may be inferred based on historical network condition information for the plurality of geographical locations. In yet another example, the current network conditions may be determined using crowd sourced network condition information.

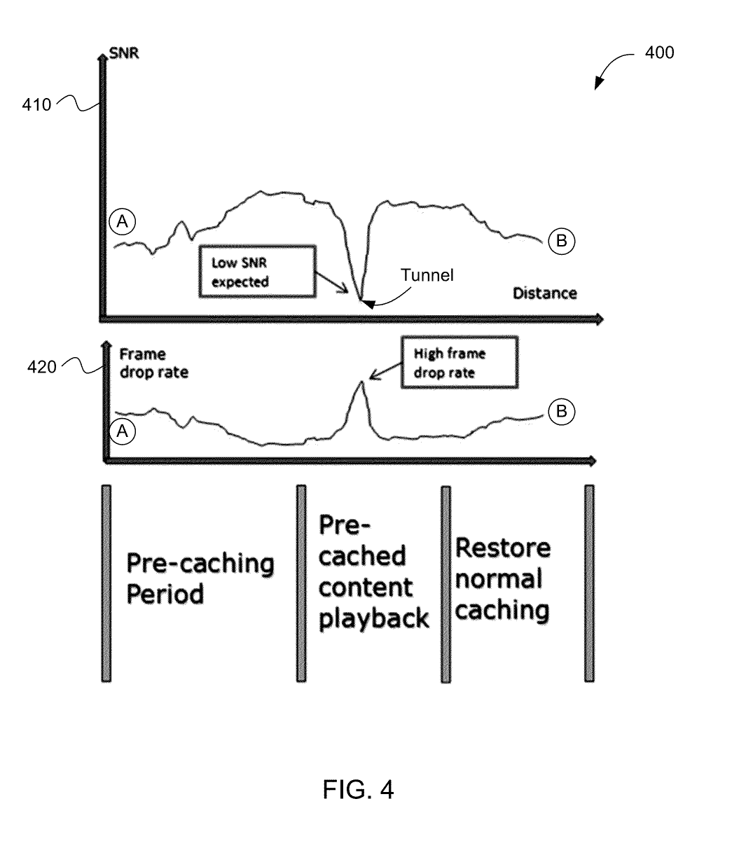

FIG. 4 illustrates network conditions along a planned route and the strategic caching of media content segments before reaching specific locations along the planned route. A user equipment (UE) may determine a planned route associated with the UE. The planned route may include a geographical route that the UE is about to embark on in order to reach a planned destination. For example, the planned route may include a route to work, school, a grocery store, movie theater, national park, etc. In one example, the UE may be within a vehicle that is also implementing the planned route in order to reach the planned destination. In other words, the UE and the vehicle may be moving simultaneously (e.g., at the same speed) along the planned route in order to reach the planned destination. The UE may include, but is not limited to, a mobile device, tablet computer, laptop computer, smart watch, etc.

In one configuration, the UE may stream media content from a media server during the planned route of the UE. The media server may be coupled to or included in the HTTP server. In other words, the UE may stream a movie, television program, etc. while traveling to the planned destination. In one example, the UE may be within a vehicle that is traveling to the planned destination. The UE may be operated by a driver or a passenger within the vehicle. In yet another example, a computing system incorporated into the vehicle may be streaming the media content to a display screen inside the vehicle while the vehicle is traveling to the planned destination.

In one example, the UE may provide a destination name or destination address to a web mapping service application. The destination name or address may be a desired destination of the UE and/or the vehicle. The web mapping service application may operate on a remote server or a cloud server. The UE may also provide a current geographical location of the UE to the web mapping service application. The UE may determine its current geographical location using global position system (GPS), triangulation, or other applicable mechanisms for determining the current geographical location of the UE. The web mapping service application may generate a planned route for the UE using the destination name/address and the current geographical location of the UE. The planned route may include a series of streets and navigational directions (e.g., left turns and right turns) for the UE to take in order for the UE to reach the destination name or destination address. The web mapping service application may provide planned route information associated with the planned route to the UE, wherein the planned route information may enable the UE to travel between the UE's current location (e.g., an office building) to the destination (e.g., a nearby park).

In an alternative configuration, a computing system incorporated into the vehicle may provide the destination name or destination address to the web mapping service application. The web mapping service application may determine a planned route to enable the vehicle to reach the desired destination. The vehicle may follow the planned route upon receiving the planned route via the web mapping service application in order to reach the desired destination.

Upon receiving the planned route information from the web mapping service application, the UE may provide the planned route information to an HTTP server. The HTTP server may include a channel information database (CID). As previously discussed, the CID may include current network conditions or wireless channel information for a plurality of geographical locations. The current network conditions may be dynamically updated in real-time based on real-time monitoring of the network and/or crowd sourced information. In addition, the current network conditions may be inferred using historical network condition information. The HTTP server may identify current network conditions for the planned route of the UE using the information stored in the CID. In other words, the HTTP server may provide the current network conditions for particular roads, bridges, etc. to be taken by the UE while traveling on the planned route. The UE may receive the current network conditions or wireless channel information for the planned route from the HTTP server.

The graphs 410 and 420 illustrate graphical examples of current network conditions or wireless channel information for the planned route. The current network conditions for the planned route may be received at the UE from the HTTP server. The planned route may start at a first geographical location (e.g., Point A) and end at a second geographical location (e.g., Point B). As an example, the distance between Point A and Point B may be 10 kilometers (km), wherein Point A is a school and Point B is a park.

In one example, the X-axis of the graph 410 may represent a distance to be traveled by the UE and the Y-axis of the graph 410 may represent an expected signal to noise ratio (SNR) value. In addition, the expected SNR value may correspond to the current network conditions for the planned route—a relatively high expected SNR value may indicate that the network conditions are favorable during those portions of the planned route and a lower expected SNR value may indicate that the network conditions are unfavorable during those portions of the planned route.

Similarly, the X-axis of the graph 420 may represent a distance to be traveled by the UE and the Y-axis of the graph 420 may represent an expected frame drop rate. The expected frame drop rate may correspond to the current network conditions for the planned route—a relatively high expected frame drop rate may indicate that the network conditions are unfavorable during those portions of the planned route and a lower expected frame drop rate value may indicate that the network conditions are favorable during those portions of the planned route.

The wireless network channel conditions of the planned path (i.e., the expected SNR values and expected frame drop rates along the planned route) may impact a user quality of experience when a media stream is being provided to the UE and/or the vehicle. For example, good network conditions (i.e., relatively high SNR values and relatively low frame drop rates) may generally result in a more desirable user quality of experience, whereas poor network conditions (i.e., relatively low SNR values and relatively high frame drop rates) may generally result in a less desirable user quality of experience.

The UE may identify locations along the planned route where wireless network channel conditions are below a defined threshold based on the wireless channel information received from the HTTP server. For example, the UE may identify locations along the planned route having expected SNR values that are below the defined threshold. Similarly, the UE may identify locations along the planned route having expected frame drop rates that exceed the defined threshold. The UE may identify the locations for which the wireless network channel conditions are expected to be below the defined threshold prior to reaching those locations along the planned route. For example, the UE may identify the locations before embarking on the planned route and/or while traveling on the planned route to the planned destination.

In the example shown in FIG. 4, the UE may identify a location along the planned route from Point A to Point B with an expected SNR value that is below the defined threshold. In addition, the location may have an expected frame drop rate that exceeds the defined threshold. The location may correspond to a bridge, tunnel, remote location, etc. where the network channel conditions are generally poor. In other words, media content that is streamed to the UE and/or vehicle from the media server at that particular location may be subject to dropped frames (i.e. a reduction in video quality) and/or interruptions in the media content playback when media content segments are buffering.

In one configuration, the UE may determine, based on the current network conditions, average transmission speeds of the media content segments that are to be provided to the UE during the planned route of the UE. For example, the UE may determine a time length of the planned route (e.g., 30 minutes). The UE may then identify the media content that is to be provided to the UE during the planned route. As an example, the UE may identify 30 minutes of the media content to be provided to the UE during a 30-minute planned route. Based on the wireless channel information for the planned route received from the HTTP server, the UE may determine an average bit rate for each of the media content segments that are to be provided during the planned route. The UE may identify media content segments that are to be received at the UE when the wireless network channel conditions are expected to be good, as well as media content segments that are to be received at the UE when the wireless network channel conditions are expected to be poor, as indicated in the wireless channel information for the planned route received from the HTTP server.

The UE may request additional media content segments from the media server prior to entering one or more locations along the planned route where wireless network channel conditions are below the defined threshold. The additional media content segments requested by the UE may have been previously identified by the UE. The UE may have identified these media content segments as initially being scheduled to be received at the UE when the network channel conditions of the planned route is expected to be poor. Therefore, the UE may request these media content segments in advance so that the media content segments are not communicated to the UE while the network channel conditions of the planned route are expected to be poor.

The UE may request the additional media content segments before entering the location according to a predefined time period. For example, the UE may request the additional media content segments two minutes before entering the location. In one configuration, the predefined time period may be dynamically updated based on the wireless network channel conditions along the planned route. The predefined time period may increase when the location encompasses a greater area (i.e., the UE is expected to be in a region with poorer network channel conditions for a greater period of time). For example, if the UE is approaching a five-minute region where network channel conditions are expected to be poor, the UE may request for the additional media content segments 20 minutes before entering the region.

The UE may store the additional media content segments in a buffer or cache associated with the UE. When the UE enters the determined location along the planned route, the UE may perform media content playback using the additional media content segments stored in the buffer or cache. In other words, the UE does not have to stream media content in locations where the network channel conditions are likely poor. As a result, continuous media content playback may be substantially enabled at the UE along the planned route, even when the UE travels in locations with poor network channel conditions. Alternatively, the UE may perform media content playback using the additional media content segments stored in the buffer while simultaneously receiving new media content segments for the storage in the buffer, wherein the new media content segments may be received at a lower bitrate because the UE is in the location with poor network conditions.

The UE may return to a previous bit rate adaptation and buffering mechanism upon exiting the determined location along the planned route. In other words, the UE may not request for additional media content segments upon exiting the determined location (unless the UE is approaching another location with network channel conditions that are below the defined threshold). In one example, the previous buffering mechanism of the UE may store a predefined size of media content segments (e.g., approximately 3 megabytes (MB) of media content segments) and does not store additional media content segments for playback in determined locations along the planned route. The UE may return to the previous bit rate adaptation upon exiting the determined location in order to benefit from the bandwidth saving offered by DASH or other similar media content streaming techniques.

In one configuration, the UE may request for additional media content segments so that a quality level of the media content stream remains substantially the same, even when the UE enters locations with relatively poor network channel conditions. For example, the UE may desire to stream media content at a constant bit rate of 100 megabits per second (Mbits/s). However, a portion of the planned route may have relatively poorer network conditions and the expected bit rate during that portion may be 70 Mbits/s. Therefore, the UE may request additional media content segments, such that the media content stream remains substantially at 100 Mbits/s for the entire planned route.

The UE may adjust a size or capacity of the buffer depending on a number of additional segments to be provided to the UE prior to entering the determined locations along the planned route for the UE. As an example, the capacity of the buffer may dynamically vary between 3 megabytes (MBs) and 1 gigabyte (GB) based on the number of additional segments to be provided to the UE. The number of additional segments stored in the buffer may increase in response to a decrease in the network channel condition. The size of the buffer may be set to a predetermined maximum (e.g., 2 GB).

In one example, the video quality of the media content stream being provided to the UE may slightly decrease when the UE is simultaneously receiving additional media content segments in anticipation of reaching a location along the planned path where the network channel conditions are poor. As an example, the video quality of the streaming media content may slightly decrease one minute prior to entering the determined location because the UE may be receiving and storing additional media content segments to enable continuous media playback when the UE reaches the determined location.

As shown in FIG. 4, the UE may receive additional media content segments prior to reaching a portion of the planned path where network channel conditions are expected to be below the defined threshold. In other words, this period or distance of the planned route may be known as a “pre-caching” phase. When the UE reaches a portion of the planned path where network channel conditions are below the defined threshold, the UE may perform media content playback using the media content segments stored in the cache. In other words, this period or distance of the planned route may be known as a “pre-cached content playback” period. The “pre-cached content playback” period may correspond to locations with a low SNR value or a high frame drop rate. After the UE exits the location with network channel conditions that are below the defined threshold, the UE may return to a previous bit rate adaptation and buffering mechanism. This period or distance of the planned route may be known as a “restore normal” period.

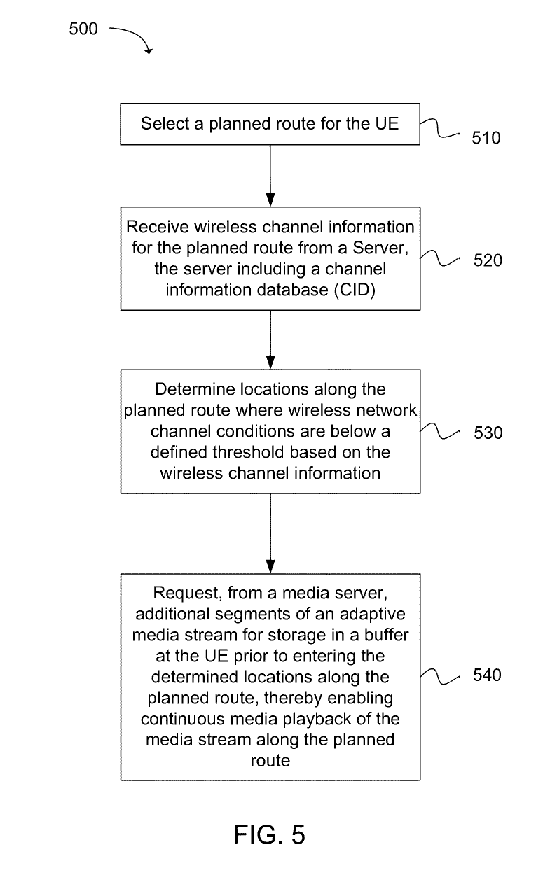

Another example provides functionality 500 of computer circuitry of a user equipment (UE) operable to perform adaptive media streaming, as shown in the flow chart in FIG. 5. The functionality may be implemented as a method or the functionality may be executed as instructions on a machine, where the instructions are included on at least one computer readable medium or one non-transitory machine readable storage medium. The computer circuitry can be configured to select a planned route for the UE, as in block 510. The computer circuitry can be further configured to receive wireless channel information for the planned route from a server, the server including a channel information database (CID), as in block 520. The computer circuitry can be further configured to determine locations along the planned route where wireless network channel conditions are below a defined threshold based on the wireless channel information, as in block 530. In addition, the computer circuitry can be configured to request, from a media server, additional segments of an adaptive media stream for storage in a buffer at the UE prior to entering the determined locations along the planned route, thereby enabling continuous media playback of the media stream along the planned route, as in block 540.

In one configuration, the computer circuitry can be further configured to play the additional segments of the adaptive media stream stored in the buffer when the UE enters the determined locations along the planned route. In addition, the computer circuitry may be further configured to adjust a capacity of the buffer at the UE depending on a number of additional segments to be provided to the UE prior to entering the determined locations along the planned route for the UE. Furthermore, the computer circuitry may be further configured to determine the locations along the planned route where the wireless network channel conditions are below the defined threshold based on expected signal to noise ratios (SNRs) along the planned route of the UE.

In one configuration, the computer circuitry may be further configured to determine the locations along the planned route where the wireless network channel conditions are below the defined threshold based on expected frame drop rates along the planned route of the UE. In one example, the wireless channel information for the planned route is determined based on at least one of historical wireless network channel conditions, current wireless network channel conditions, or crowd sourced wireless network conditions. In addition, the wireless channel information is periodically updated for the planned route based on variations in wireless network channel conditions for the planned route. In one example, the UE includes an antenna, a touch sensitive display screen, a speaker, a microphone, a graphics processor, an application processor, internal memory, or a non-volatile memory port.

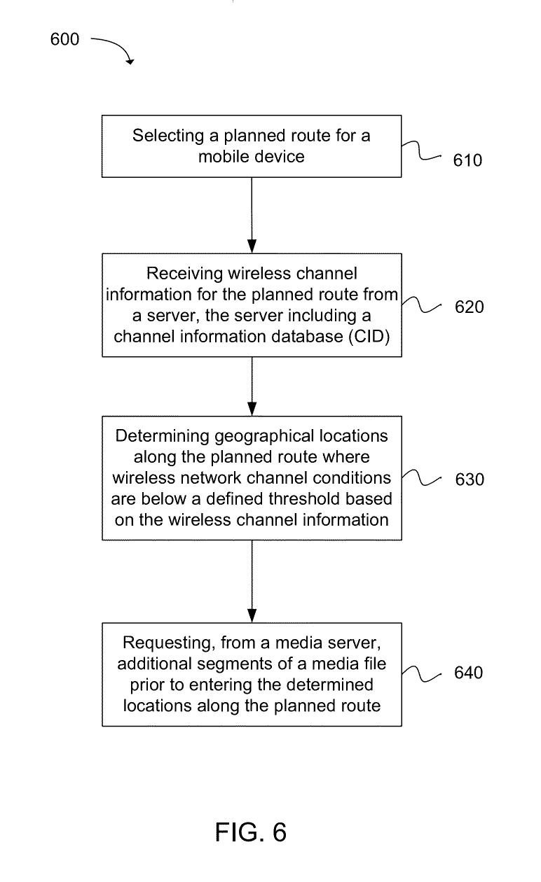

Another example provides a method 600 for performing dynamic adaptive streaming over hypertext transfer protocol (DASH), as shown in the flow chart in FIG. 6. The method may be executed as instructions on a machine, where the instructions are included on at least one computer readable medium or one non-transitory machine readable storage medium. The method includes the operation of selecting a planned route for a mobile device, as in block 610. The method can include receiving wireless channel information for the planned route from a server, the server including a channel information database (CID), as in block 620. The method can further include determining geographical locations along the planned route where wireless network channel conditions are below a defined threshold based on the wireless channel information, as in block 630. In addition, the method can include requesting, from a media server, additional segments of a media file prior to entering the determined locations along the planned route, as in block 640.

In one example, the method can further comprise receiving the additional segments of the media file for storage in a buffer at the mobile device. In addition, the method can further comprise receiving the additional segments of the media file to enable continuous media playback of the media file during geographical locations along the planned route where the wireless network channel conditions are below the defined threshold. In addition, the method can comprise adjusting a buffer capacity of the mobile device depending on a number of additional segments of the media file to be provided to the mobile device prior to entering the determined locations along the planned route.

In one configuration, the method can further comprise determining that the wireless network channel conditions at the geographical locations along the planned route are below the defined threshold based on expected signal to noise ratios (SNRs) along the planned route of the mobile device. In addition, the method can comprise determining that the wireless network channel conditions at the geographical locations along the planned route are below the defined threshold based on expected frame drop rates along the planned route of the mobile device. In one example, the method can further comprise receiving the wireless channel information from the CID via the server based on historical data of wireless network channel conditions for the planned route. Furthermore, the method can comprise receiving the wireless channel information from the CID via the server based on current wireless network channel conditions for the planned route. In yet another example, the method may include restoring a previous DASH rate adaptation and buffering mechanism after exiting the determined locations along the planned route.

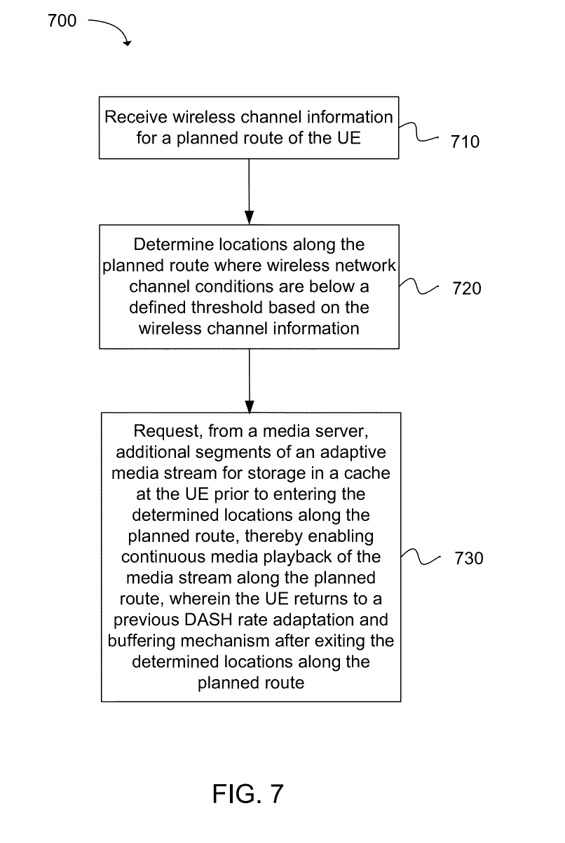

Another example provides functionality 700 of computer circuitry of a user equipment (UE) operable to perform dynamic adaptive streaming over hypertext transfer protocol (DASH), as shown in the flow chart in FIG. 7. The functionality may be implemented as a method or the functionality may be executed as instructions on a machine, where the instructions are included on at least one computer readable medium or one non-transitory machine readable storage medium. The computer circuitry can be configured to receive wireless channel information for a planned route of the UE, as in block 710. The computer circuitry can be configured to determine locations along the planned route where wireless network channel conditions are below a defined threshold based on the wireless channel information, as in block 720. The computer circuitry can be further configured to request, from a media server, additional segments of an adaptive media stream for storage in a cache at the UE prior to entering the determined locations along the planned route, thereby enabling continuous media playback of the media stream along the planned route, wherein the UE returns to a previous DASH rate adaptation and buffering mechanism after exiting the determined locations along the planned route, as in block 730.

In one configuration, the computer circuitry can be further configured to play the additional segments of the adaptive media stream stored in the cache when the UE enters the determined locations along the planned route. In addition, the computer circuitry can be further configured to adjust a capacity of the cache at the UE depending on a number of additional segments to be provided to the UE prior to entering the determined locations along the planned route for the UE. Furthermore, the computer circuitry can be configured to determine the locations along the planned route where the wireless network channel conditions are below the defined threshold based on expected signal to noise ratios (SNRs) or expected frame drop rates along the planned route of the UE. In one example, the computer circuitry can be further configured to receive the wireless channel information for the planned route from a server that includes a channel information database (CID), wherein the wireless channel information is based on historical data of wireless network channel conditions for the planned route or current wireless network channel conditions for the planned route.

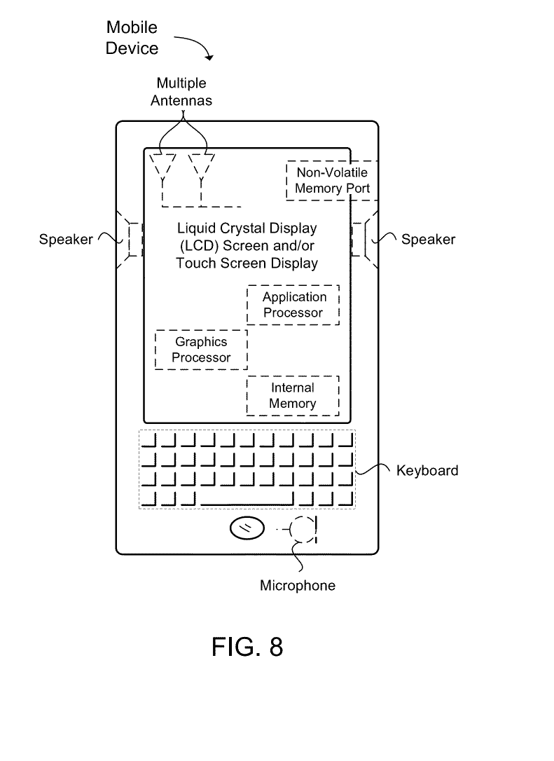

FIG. 8 provides an example illustration of the wireless device, such as a user equipment (UE), a mobile station (MS), a mobile wireless device, a mobile communication device, a tablet, a handset, a computing device, or other type of wireless device. The wireless device can include one or more antennas configured to communicate with a node or transmission station, such as a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The wireless device can be configured to communicate using at least one wireless communication standard including 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 8 also provides an illustration of a microphone and one or more speakers that can be used for audio input and output from the wireless device. The display screen may be a liquid crystal display (LCD) screen, or other type of display screen such as an organic light emitting diode (OLED) display. The display screen can be configured as a touch screen. The touch screen may use capacitive, resistive, or another type of touch screen technology. An application processor and a graphics processor can be coupled to internal memory to provide processing and display capabilities. A non-volatile memory port can also be used to provide data input/output options to a user. The non-volatile memory port may also be used to expand the memory capabilities of the wireless device. A keyboard may be integrated with the wireless device or wirelessly connected to the wireless device to provide additional user input. A virtual keyboard may also be provided using the touch screen.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A user equipment (UE) operable to perform adaptive media streaming, the UE having computer circuitry configured to:
select a planned route for the UE;
receive wireless channel information for the planned route from a server, the server including a channel information database (CID);
determine locations along the planned route where wireless network channel conditions are below a defined threshold based on the wireless channel information; and
request, from a media server, additional segments of an adaptive media stream for storage in a buffer at the UE prior to entering the determined locations along the planned route, thereby enabling continuous media playback of the media stream along the planned route.

2. The computer circuitry of claim 1, further configured to play the additional segments of the adaptive media stream stored in the buffer when the UE enters the determined locations along the planned route.

3. The computer circuitry of claim 1, further configured to adjust a capacity of the buffer at the UE depending on a number of additional segments to be provided to the UE prior to entering the determined locations along the planned route for the UE.

4. The computer circuitry of claim 1, further configured to determine the locations along the planned route where the wireless network channel conditions are below the defined threshold based on expected signal to noise ratios (SNRs) along the planned route of the UE.

5. The computer circuitry of claim 1, further configured to determine the locations along the planned route where the wireless network channel conditions are below the defined threshold based on expected frame drop rates along the planned route of the UE.

6. The computer circuitry of claim 1, wherein the wireless channel information for the planned route is determined based on at least one of historical wireless network channel conditions, current wireless network channel conditions, or crowd sourced wireless network conditions.

7. The computer circuitry of claim 1, wherein the wireless channel information is periodically updated for the planned route based on variations in wireless network channel conditions for the planned route.

8. The computer circuitry of claim 1, wherein the UE includes an antenna, a touch sensitive display screen, a speaker, a microphone, a graphics processor, an application processor, internal memory, or a non-volatile memory port.

9. A method for performing dynamic adaptive streaming over hypertext transfer protocol (DASH), the method comprising:
selecting a planned route for a mobile device;
receiving wireless channel information for the planned route from a server, the server including a channel information database (CID);
determining geographical locations along the planned route where wireless network channel conditions are below a defined threshold based on the wireless channel information; and
requesting, from a media server, additional segments of a media file prior to entering the determined locations along the planned route.

10. The method of claim 9, further comprising receiving the additional segments of the media file for storage in a buffer at the mobile device.

11. The method of claim 9, further comprising receiving the additional segments of the media file to enable continuous media playback of the media file during geographical locations along the planned route where the wireless network channel conditions are below the defined threshold.

12. The method of claim 9, further comprising adjusting a buffer capacity of the mobile device depending on a number of additional segments of the media file to be provided to the mobile device prior to entering the determined locations along the planned route.

13. The method of claim 9, further comprising determining that the wireless network channel conditions at the geographical locations along the planned route are below the defined threshold based on expected signal to noise ratios (SNRs) along the planned route of the mobile device.

14. The method of claim 9, further comprising determining that the wireless network channel conditions at the geographical locations along the planned route are below the defined threshold based on expected frame drop rates along the planned route of the mobile device.

15. The method claim 9, further comprising receiving the wireless channel information from the CID via the server based on historical data of wireless network channel conditions for the planned route.

16. The method claim 9, further comprising receiving the wireless channel information from the CID via the server based on current wireless network channel conditions for the planned route.

17. The method of claim 9, further comprising restoring a previous DASH rate adaptation and buffering mechanism after exiting the determined locations along the planned route.

18. A user equipment (UE) operable to perform dynamic adaptive streaming over hypertext transfer protocol (DASH), the UE having computer circuitry configured to:
receive wireless channel information for a planned route of the UE;
determine locations along the planned route where wireless network channel conditions are below a defined threshold based on the wireless channel information; and
request, from a media server, additional segments of an adaptive media stream for storage in a cache at the UE prior to entering the determined locations along the planned route, thereby enabling continuous media playback of the media stream along the planned route, wherein the UE returns to a previous DASH rate adaptation and buffering mechanism after exiting the determined locations along the planned route.

19. The computer circuitry of claim 17, further configured to play the additional segments of the adaptive media stream stored in the cache when the UE enters the determined locations along the planned route.

20. The computer circuitry of claim 17, further configured to adjust a capacity of the cache at the UE depending on a number of additional segments to be provided to the UE prior to entering the determined locations along the planned route for the UE.

21. The computer circuitry of claim 17, further configured to determine the locations along the planned route where the wireless network channel conditions are below the defined threshold based on expected signal to noise ratios (SNRs) or expected frame drop rates along the planned route of the UE.

22. The computer circuitry of claim 17, further configured to receive the wireless channel information for the planned route from a server that includes a channel information database (CID), wherein the wireless channel information is based on historical data of wireless network channel conditions for the planned route or current wireless network channel conditions for the planned route.
